(19) United States
(12) Patent Application Publication
(10) Pub. No.: US 2009/0282079 A1
(43) Pub. Date: Nov. 12, 2009

(54) METHOD OF TRANSFERRING DATA

(75) Inventors: Eugene Ivanov, Eindhoven (NL); Alexander Wilhelmus Heerink, Wierden (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,411

(22) PCT Filed: Jun. 11, 2007
(86) PCT No.: PCT/IB07/52195

§ 371 Date: Dec. 18, 2008

(30) Foreign Application Priority Data
Jun. 22, 2006 (EP) 06115856.4

(51) Int. Cl. G06F 17/30

(52) U.S. Cl. 707/104.1; 707/E17.032

(57) ABSTRACT

In a telemonitoring system, a number of telemonitoring devices collect patient data. If an abnormality occurs, a monitoring center is sent a signal. Depending on the abnormality, the monitoring center may request more patient data in order to analyze and evaluate the occurred abnormality. To this end, the patient may be requested to send the telemonitoring devices to the monitoring center. In order to minimize overhead costs and increase efficiency, the present invention provides a method and system for transferring the requested data to a minimum number of selected devices, preferably one selected device, so that a minimum number of selected devices needs to be sent to the monitoring center.

### FIELD OF THE INVENTION

The present invention relates to a method of transferring data and in particular to a method of transferring data distributed over a number of data blocks of a set of devices.

### BACKGROUND OF THE INVENTION

For monitoring a patient, for example a heartbeat rhythm of the patient, it is known to have the patient wear a telemonitoring device. The telemonitoring device, being part of a telemonitoring system, is a battery-operated wearable device configured for continuously collecting data from the patient. The patient data are locally stored in a memory of the telemonitoring device.

A known telemonitoring system comprises a number of telemonitoring devices such that a battery of a first telemonitoring device may be (re-)charged, while a second telemonitoring device is worn and collects patient data. When the battery of the second telemonitoring device is exhausted, for example, a switch to the first telemonitoring device is made. Consequently, in the end, a part of the collected patient data is stored on the first telemonitoring device, while another part of the collected patient data is stored on the second telemonitoring device.

Apart from collecting patient data, the telemonitoring device may detect abnormalities in e.g. the heart rhythm of the patient and, in response thereto, send an alarm (alert) signal to a monitoring center through a suitable communication connection, e.g. using a (mobile) phone system. Such an alarm signal may comprise the patient data collected just prior to sending the alarm signal, i.e including the data relating to the detected abnormality. In the monitoring center, a person skilled in analyzing and evaluating patient data may review the patient data comprised in the alarm signal.

In certain instances, the evaluating person may request additional data, for example data relating to a longer period of time prior to the detected abnormality. The request may be sent to the telemonitoring device worn by the patient. However, as described above, the requested patient data may be distributed over the number of telemonitoring devices. As it is usually unknown to the evaluating person, and to the patient, on which telemonitoring device the requested data are stored, and since supplying the data of each telemonitoring device through a telecommunication line would take a large period of time, thereby rendering the transmission very costly, it is known to send each telemonitoring device to the monitoring center for evaluation. In order to enable telemonitoring while the data are still being collected, analyzed and evaluated, the patient may be provided with replacement telemonitoring devices.

The need to replace the telemonitoring devices has the disadvantage that a number of replacement devices has to be kept in stock, resulting in additional costs for storage and additional costs due to depreciation of the devices. Further, the technician retrieving the patient data needs to query all data stored on each telemonitoring device sent to the monitoring center in order to find and be able to retrieve the needed patient data.

### OBJECT OF THE INVENTION

It is desirable to have a method and system wherein not all telemonitoring devices need to be sent to the monitoring center for retrieving a part of the collected patient data.

### SUMMARY OF THE INVENTION

The present invention provides in an aspect a method of transferring a predetermined part of data from at least one data storage device to a server, the data being distributed over a number of data storage devices, the method comprising:
(a) determining which data storage devices store at least a part of the predetermined part of the data;
(b) if the predetermined part of the data is stored on one of the data storage devices:
(b1) transferring the predetermined part of the data from said one of the data storage devices to the server;
(c) if the predetermined part of the data is distributed over two or more of the data storage devices:
(c1) storing the predetermined part of the data on at least one selected data storage device by transferring relevant data from each of said two or more data storage devices to said one selected data storage device;
(c2) transferring the predetermined part of the data from said at least one selected data storage device to the server.

In the above method, parts of the predetermined part of the data, i.e. the part of the data requested by the monitoring center for evaluation, for example, are retrieved from the respective data storage devices and stored on at least one, preferably only one, data storage device, so that only one data storage device needs to be supplied to the monitoring center, where the predetermined part of the data is transferred to the server. To this end, it is first determined which data storage device(s) store(s) a relevant part of the data. A relevant part of the data, or relevant data, hereinafter, refers to a part of the predetermined part of the data. The relevant part of the data is therefore to be stored, possibly with other relevant data parts, on at least one data storage device. The predetermined part of the data may be stored on one of the data storage devices or may be distributed over more than one data storage device.

If the predetermined part of the data is stored on one data storage device, that data storage device is to be sent to the monitoring center for transferring the predetermined part of the data from the data storage device to the server for e.g. evaluation.

If the predetermined part of the data is distributed over a number of data storage devices, two or more storage devices are queried in order to determine which data are stored on each data storage device. All relevant parts of the data are transferred to one selected data storage device. Thus, all data that are parts of the predetermined part of the data are transferred to the one selected data storage device. Eventually, the predetermined part of the data is stored on the at least one selected data storage device. Preferably, the predetermined part of the data is stored on one selected device. However, if the predetermined part cannot be stored on one data storage device, the predetermined part may be stored on a number of storage devices. The method according to the present invention is then advantageously employed to minimize the number of selected devices. The at least one selected data storage device is sent to the monitoring center and the predetermined part of the data is transferred to the server.

In an embodiment, the method step (c1) comprises, prior to storing the predetermined part of the data, transferring non-relevant data from the selected data storage device to another data storage device for saving said non-relevant data. When a relevant part of the data is found on a first data storage device and is transferred to the selected data storage device, non-relevant data stored on the selected data storage device may be overwritten. However, data that is at present non-relevant, may become relevant at a later date. Therefore, to conserve the non-relevant data, the non-relevant data may be stored on another data storage device, such as said first data storage device. In particular, if the non-relevant data is stored on the first data storage device, an additional storage medium may be used to temporarily store the non-relevant data; transfer the relevant data from the first data storage device to the selected data storage device; and then transfer the non-relevant data from the additional storage medium to the first data storage device, thereby possibly overwriting the relevant data stored on the first data storage device.

In an embodiment of the method, only one of the data storage devices may be active at a time. Since data may only be transferred to or from a data storage device when the data storage device is active, step (a) of the embodiment of the method further comprises
(a1) activating a data storage device;
(a2) determining whether the active data storage device stores at least a part of the predetermined part of the data; and
(a3) repeating steps (a1) and (a2) for another data storage device if not all data of the predetermined part of data are retrieved.

It is noted that, if the predetermined part of the data is stored on one data storage device, upon determining that the active data storage device stored the predetermined part of the data, the other data storage devices do not need to be activated and queried anymore, since all data of the predetermined part of the data are located and may be retrieved. Similarly, if a first and a second data storage device together store all relevant data, a third data storage device does not need to be queried anymore.

In an embodiment, step (a) comprises, prior to the determining step, synchronizing a clock of the data storage device and a clock of the server. The predetermined part of the data may relate to a data collection period in time. Thus, relevant data relate to data collected in said period of time. In order to prevent that non-relevant data (i.e. not collected in said period of time) is determined to be relevant due to a different time setting of the data storage device and a time reference, the clock of the data storage device is synchronized with the clock of the time reference. The time reference may be provided by the server, one of the data storage devices, any other device used in the method, such as a communication device for communication between a data storage device and the server, or a time server publicly available e.g. on the Internet, or the like.

In an embodiment, step (a) further comprises determining which data storage device stores the largest part of the predetermined part of the data compared to the other data storage devices; and storing the predetermined part of data on said data storage device storing said largest part. Thus, a minimum amount of data is transferred between the data storage devices, thereby minimizing the power used for data transfer.

In an aspect, the present invention provides a data collection device configured for use in the method according to the present invention. For this purpose, the data collection device comprises a data collection unit for collecting the part of the data; a data storage device for storing the part of the data; a device clock for time stamping the stored part of the data relating to a data collection time period; and a communication device for communicating to a server which part of the data is stored in the data storage device; and for transferring stored data to another data collection device and/or receiving data from another data collection device and for transferring stored data to the server. In an embodiment, the data storage device is a removable data storage device, so that only the data storage device needs to be sent to the monitoring center instead of the complete data collection device.

In a further aspect, the present invention provides a communication device for communicating with a data storage device storing at least a part of data, the data being distributed over a number of data storage devices, the communication device being configured for determining which part of a predetermined part of the data is stored on a data storage device. In an embodiment, the communication device comprises a memory for temporarily storing data in order to transfer data from a first data storage device to a second device.

In a further aspect, the present invention provides a data management system, the system comprising at least two data collection devices according to the invention, a communication device according to the invention and a server, the server being configured for sending a data request to the communication device for requesting a predetermined part of data stored on the at least two data storage devices, and the communication device being configured for transferring all relevant data to at least one selected data storage device, so that the predetermined part of the data is stored on the selected data storage device.

### BRIEF DESCRIPTION OF THE DRAWINGS

Hereinafter the present invention is elucidated in more detail with reference to the appended drawings illustrating non-limiting embodiments, wherein

FIG. 1 illustrates a telemonitoring system;

FIG. 2A shows a timing diagram for illustrating an operation of the telemonitoring system of FIG. 1;

FIG. 2B shows a block of patient data generated by the telemonitoring system of FIG. 1;

FIG. 3 shows a flow diagram illustrating the method according to the present invention;

FIG. 4 illustrates an embodiment of the method according to the present invention; and

FIG. 5 illustrates an embodiment of a data management system according to the present invention.

### DETAILED DESCRIPTION OF EXAMPLES

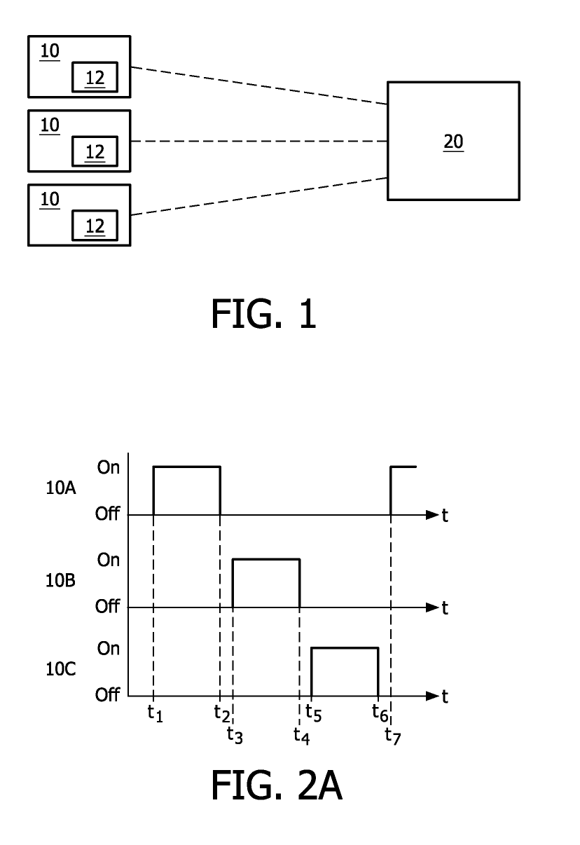

In the drawings, like reference numerals refer to like components. FIG. 1 shows schematically a telemonitoring system. The telemonitoring system comprises at least one telemonitoring device 10 and a monitoring center 20. The telemonitoring system is configured for monitoring a patient, such as a heart patient, without the patient being required to be at a specific location, such as in hospital. Hereinafter, the telemonitoring system is described and illustrated in relation to a patient, whose heart is monitored. The present invention, however, is not limited to such a heart patient monitoring system, but is also applicable to any other monitoring system. Moreover, the present invention may be applicable in any system in which an amount of data is distributed over and stored in a memory of a number of separate devices.

Referring to FIG. 1, a telemonitoring device 10 is worn by a patient. The telemonitoring device 10 may, for example, comprise a sensor for registering a heartbeat of the patient. Thus, patient data is collected. The telemonitoring device 10 may further comprise a data storage device 12 for storing the collected patient data. Further, during data collection, the telemonitoring device 10 may analyze the collected data such that an abnormality in the heart rhythm may be detected. Upon detection of an abnormality, the telemonitoring device 10 may then send an alert signal or an alarm signal to the monitoring center 20. Depending on the severeness of the detected abnormality, the alarm signal may be stored at the monitoring center 20 together with heartbeat data relating to the detected abnormality for later review, or in response to the alarm signal, a medically trained person may be sent to the patient for medical assistance.

When reviewing the heartbeat data at a later point in time, for example for diagnosing the patient, more heartbeat data may be required. In such a case, a request for more data, in particular a predetermined part of the data, like data relating to a time period prior to the occurrence of the abnormality or data relating to a same time period of other days, is sent to the telemonitoring device 10. In response thereto, the telemonitoring device 10 may send the requested data to the monitoring center 20 or the patient may send the telemonitoring device 10 to the monitoring center 20 by mail, so that the relevant data may be retrieved from the data storage device 12 of the telemonitoring device 10 at the monitoring center 20. In particular, if the amount of data of the predetermined part of the data is relatively large, it may be preferred to send at least the data storage device 12 to the monitoring center 20.

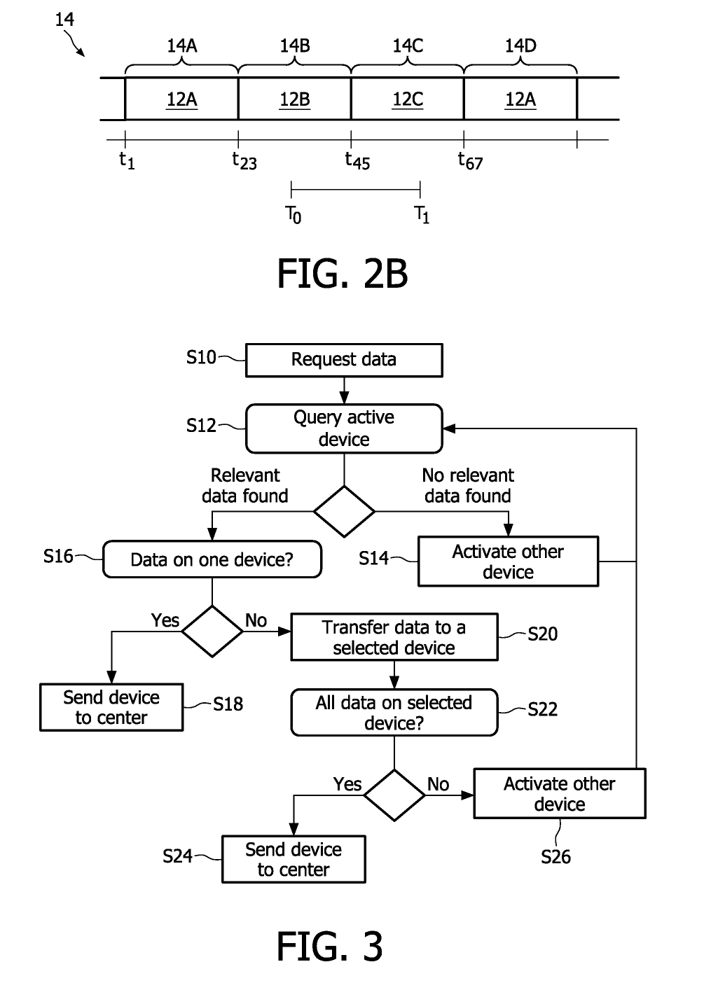

In a practical embodiment of the telemonitoring system, however, the collected data is stored in multiple data storage devices 12 of multiple telemonitoring devices 10, as explained in relation to FIG. 2A. FIG. 2A shows a timing diagram of the use of a first telemonitoring device 10A, a second telemonitoring device 10B and a third telemonitoring device 10C. Since the telemonitoring devices 10A-10C are battery-operated for enabling a patient to wear the telemonitoring device 10A-10C, each telemonitoring device 10A-10C needs to be charged when the battery is exhausted. Therefore, when one telemonitoring device 10A-10C is actively collecting data, another telemonitoring device 10A-10C may be (re)charged. The telemonitoring device 10A-10C collecting data may herein be referred to as the active telemonitoring device 10A-10C. A data communication connection may be established only with the active telemonitoring device 10A-10C.

Referring to FIG. 2A, the first telemonitoring device 10A is switched on, i.e. actively collecting heartbeat data, during a first time interval [t1-t2]. The collected heartbeat data is stored in the corresponding data storage device 12A of the telemonitoring device 10A. During the first time interval [t1-t2], the second and third telemonitoring devices 10B and 10C are switched off, i.e. are inactive. At time t2, the battery of the first telemonitoring device 10A is exhausted, for example. Therefore, or for any other reason, the first telemonitoring device 10A is switched off. Thereafter, at time t3, the second telemonitoring device 10B is switched on and starts to collect data. The data collected during the second time interval [t3-t4] is stored in the corresponding data storage device 12B of the second telemonitoring device 10B. At time t4, the second telemonitoring device 10B is switched off and at time t5, the third device 10C is switched on. The data collected during the third time interval [t5-t6] is stored in the corresponding data storage device 12C of the third telemonitoring device 10C. At time t7, the first telemonitoring device 10A is used again for collecting data. Thus, a block of data relating to the heartbeat of the patient during the time period [t1-t6] is stored in three subblocks of data, each subblock being stored in a data storage device 12A-12C of a respective telemonitoring device 10A-10C.

In FIG. 2B, a data block 14 is illustrated. The data block 14 comprises a first subblock 14A, a second subblock 14B, a third subblock 14C and a fourth subblock 14D. Referring to FIGS. 2A and 2B, the first data subblock 14A comprises patient data collected during the first time interval [t1-t2]; the second data subblock 14B comprises data collected during the second time interval [t3-t4]; and the third data subblock 14C comprises data collected during the third time interval [t5-t6]. The fourth data subblock 14D comprises data collected after time t7 and stored in the data storage device 12A of the first telemonitoring device 10A. Since no data is collected in the time intervals [t2-t3], [t4-t5] and [t6-t7], the data block 14 does not comprise data relating to those time intervals and the boundaries between the data subblocks 14A-14D are indicated to be at a time t23, t45, t67, respectively. It is noted that, in an embodiment, the data collection time periods may be consecutive or may overlap. In the latter case, only a part of the stored relevant data may be retrieved from the telemonitoring device 10, since the overlapping data may be retrieved from another telemonitoring device 10, or all relevant data including overlapping data is transferred.

If, for evaluation, patient data is requested, for example patient data relating to a time period [T0-T1], i.e. a predetermined part of the data is requested, the relevant data is partly comprised in the second subblock 14B and partly comprised in the third subblock 14C and is thus distributed over the second telemonitoring device 10B and the third telemonitoring device 10C. According to the prior art, at least telemonitoring devices 10B and 10C need to be mailed to the monitoring center 20 (FIG. 1) for data retrieval.

FIG. 3 illustrates a method according to the present invention, in which the requested predetermined part of the data is first stored on one selected data storage device, and only said one selected data storage device, possibly together with the corresponding telemonitoring device, is mailed to the monitoring center.

In step S10, a server at the monitoring center sends a request for a predetermined part of historically collected data to a telemonitoring system comprising a number of telemonitoring devices. The request, which may, for example, indicate a period of time, asks for the data collected during said period of time.

Upon receipt of the request from the server, in step S12, an active telemonitoring device (i.e. a data collection device) is queried for data stored on its data storage device. If no relevant data, i.e. data collected during the period of time indicated in the request, is found on the active device, another telemonitoring device is activated in step S14, e.g. by requesting the user to activate another telemonitoring device and the method returns to step S12.

If relevant data is found on the active telemonitoring device, it is determined in step S16 whether all relevant data, i.e. a predetermined part of the data relating to the indicated period of time, is stored on the one telemonitoring device. If the one telemonitoring device stores all requested data, i.e. the predetermined part of the data, in step S18 the user is requested to send said one telemonitoring device, or only its data storage device, if the data storage device is removable, to the monitoring center for data analysis.

If it is determined that not all relevant data is stored on the one telemonitoring device, in step S20, the found relevant data is transferred to a selected data storage device, for example a data storage device comprised in one of the telemonitoring devices or a data storage device comprised in a communication device or any other device used in the method. If the relevant data is found in a telemonitoring device that is the selected data storage device, then the data does not need to be transferred.

In step S22, it is verified whether all requested data is gathered on the selected data storage device. If the predetermined part of the data is stored on the selected device, the user is requested to send at least the selected data storage device, or e.g. the device in which it is comprised, to the monitoring center in step S24.

If not all relevant data is stored on the selected data storage device, in step S26, another telemonitoring device is activated, for example by instructing the user, and the method returns to step S12.

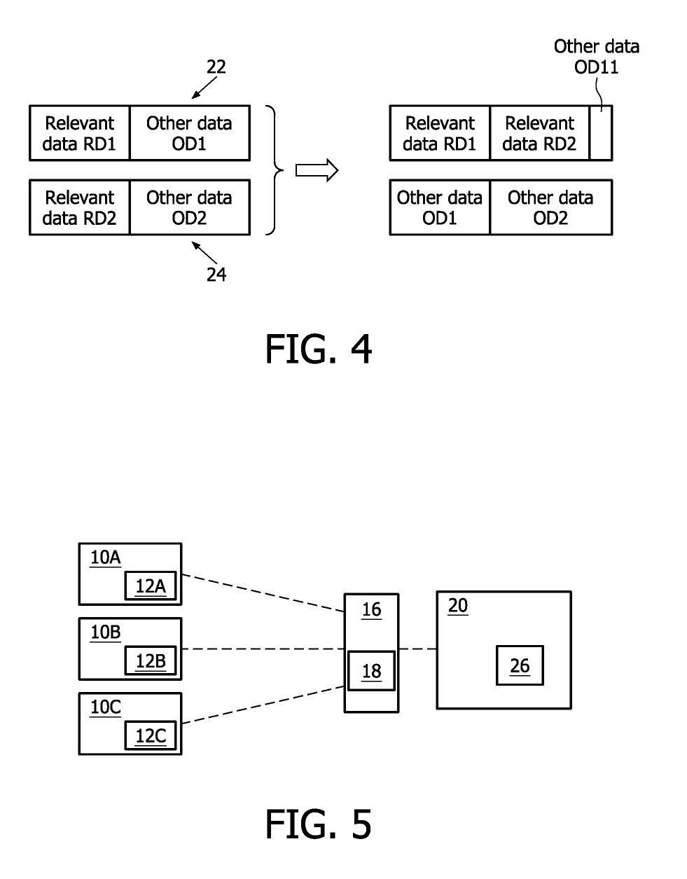

In FIG. 4, a part of an embodiment of the method of FIG. 3 is illustrated. A data storage device 22 is indicated to store a first relevant data block RD1 and a first non-relevant, other data block OD1. Another data storage device 24 is indicated to store a second relevant data block RD2 and a second non-relevant, other data block OD2. When storing all relevant data, i.e. the first relevant data block RD1 and the second relevant data block RD2, on one data storage device, i.e. the first data storage device 22, at least a part of the first other data OD1 is overwritten by the second relevant data block RD2. In order to prevent data loss as much as possible, the first other data OD1 may be stored in the second data storage device 24 at the location of the second relevant data block RD2. Depending on the data block sizes of the first other data block OD1 and the second relevant data block RD2, some data of the first other data block OD1 may remain at the first data storage device 22 and may thus not be stored on the second data storage device 24. In FIG. 4, a remaining data block is indicated as a further other data block OD11.

FIG. 5 illustrates an embodiment of a data management system according to the present invention, comprising a server 26 at a monitoring center 20, a communication device 16 comprising a storage medium 18, and a number of telemonitoring devices 10A-10C, each comprising a respective data storage device 12A-12C. The communication device 16 is configured for communication with the server 26 of the monitoring center 20. Thus, the communication device 16 is enabled to receive a request for a predetermined part of the data stored on the storage devices 12A-12C. The communication device 16 may for example be a mobile phone for telephone communication with the server 26 or may be a computer device enabled for a data network connection, e.g. through the Internet, with the server 26.

Further, the communication device 16 is configured for communicating with the telemonitoring devices 10A-10C. Thus, the communicating device 16 may query each telemonitoring device 10A-10C for the data stored on the respective data storage devices 12A-12C in order to determine which data storage device 12A-12C stores relevant data. Further, the communication device 16 is configured for transferring data to and from the telemonitoring devices 10A-10C in order to store the requested predetermined part of the data on one selected data storage device 12A-12C, so that only one of the data storage devices 12A-12C or one of telemonitoring devices 10A-10C needs to be mailed to the monitoring center 20 for transferring the predetermined part of the data to the server 26.

The storage medium 18 may advantageously be used for swapping data blocks as suggested in relation to FIG. 4. For example, referring to FIGS. 4 and 5, the first other data block OD1 may first be transferred to the storage medium 18. Then, the second relevant data block RD2 may be transferred to the first data storage device 22, thereby overwriting the first other data block OD1. Then the first other data block OD1 may be transferred to the second data storage device 24, thereby overwriting the second relevant data block RD2. The storage medium 18 may as well store metadata relating to the data stored on each data storage device 12A-12C after having queried each telemonitoring device 10A-10C, said metadata being for later use, when other data may be requested by the server 26.

Further, in an embodiment, the storage medium 18 may be employed for storing the predetermined part of the data. Then, the communication device 16 or the storage medium 18, if the storage medium 18 is a removable data storage device, may be sent to the monitoring center instead of one or more telemonitoring devices.

In an embodiment, the request for data may carry a delay parameter. For example, if the user is to send a telemonitoring device, a replacement telemonitoring device may be send to the user. The delay parameter may be used to provide the patient with information on when the replacement telemonitoring device is expected to be delivered or the delay parameter may be used to have the request be latent for a period of time until the replacement telemonitoring device is expected to be delivered.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting the scope of the invention, but merely as a basis for the claims and as a representative basis for teaching a person skilled in the art to variously employ the present invention in virtually any appropriately detailed structure. Further, the mere fact that certain measures are recited in mutually different dependent claims does not indicate that a combination of these measures cannot be used to advantage.

Further, the terms and phrases used herein are not intended to be limiting, but rather to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily by means of wires.

1. Method of transferring a predetermined part of data from at least one data storage device (12) to a server (26), the data being distributed over a number of data storage devices, the method comprising:
(a) determining which data storage devices store at least a part of the predetermined part of the data;
(b) if the predetermined part of the data is stored on one of the data storage devices:
(b1) transferring the predetermined part of the data from said one of the data storage devices to the server;
(c) if the predetermined part of the data is distributed over two or more of the data storage devices:
(c1) storing the predetermined part of the data on at least one selected data storage device by transferring relevant data from each of said two or more data storage devices to the selected data storage device;
(c2) transferring the predetermined part of the data from the selected data storage device to the server.

2. Method according to claim 1, wherein the method step (c1) comprises, prior to storing the predetermined part of the data, transferring non-relevant data from the selected data storage device to another data storage device for saving said non-relevant data.

3. Method according to claim 1, wherein only one of the data storage devices may be active at a time, step (a) of the method comprising:
(a1) activating a data storage device;
(a2) determining whether the active data storage device stores at least a part of the predetermined part of the data; and
(a3) repeating steps (a1) and (a2) for another data storage device, if not all data of the predetermined part of data are retrieved.

4. Method according to claim 1, wherein step (a) comprises, prior to the step of determining, synchronizing a clock of the data storage device and a clock of a time reference.

5. Method according to claim 1, wherein step (a) further comprises determining which data storage device stores a largest part of the predetermined part of the data compared to the other data storage devices; and storing the predetermined part of data on said data storage device storing the largest part.

6. Data collection device (10) for collecting and storing at least a part of data, the data collection device comprising:
a data collection unit for collecting the part of the data;
a data storage device (12) for storing the part of the data;
a device clock for time stamping the stored part of the data relating to a data collection time period; and
a communication device for communicating with another device (16, 26); for transferring stored data to another data collection device (10) and/or receiving data from another data collection device (10) and for transferring stored data to a server (26).

7. Data collection device according to claim 6, wherein the data storage device is a removable data storage device.

8. Communication device (16) for communicating with a data storage device (12) storing at least a part of data, the data being distributed over a number of data storage devices, the communication device being configured for determining which part of a predetermined part of the data is stored on a data storage device.

9. Communication device according to claim 8, wherein the communication device comprises a memory (18) for temporarily storing data in order to transfer data from a first data storage device to a second data storage device.

10. Communication device according to claim 9, wherein the memory (18) is a data storage device configured for storing the predetermined part of the data and for transferring data to a server.

11. Communication device according to claim 10, wherein the memory (18) is a removable data storage device.

12. Data management system, the system comprising at least two data collection devices (10) for collecting and storing at least a part of data, the data collection device comprising:
a data collection unit for collecting the part of the data;
a data storage device (12) for storing the part of the data;
a device clock for time stamping the stored part of the data relating to a data collection time period; and
a communication device for communicating with another device (16, 26); for transferring stored data to another data collection device (10) and/or receiving data from another data collection device (10) and for transferring stored data to a server (26), a communication device (16) according to claim 8 and a server (26), wherein the server is configured for sending a data request to the communication device for requesting a predetermined part of data stored on the at least two data storage devices, and the communication device is configured for transferring all relevant data to at least one selected data storage device, so that the predetermined part of the data is stored on the selected data storage device.
